(19) United States
(12) Patent Application Publication
(10) Pub. No.: US 2026/0296914 A1
(43) Pub. Date: Oct. 1, 2026

(54) Method for Preparing Nano Nickel Oxide/Graphene Composite Electrode Material

(71) Applicant: TIANNENG BATTERY GROUP CO., LTD., Huzhou, Zhejiang (CN)

(72) Inventors: Hao ZHANG, Huzhou, Zhejiang (CN); Haiyuan ZHANG, Huzhou, Zhejiang (CN); Tianren ZHANG, Huzhou, Zhejiang (CN); Hongjie WANG, Huzhou, Zhejiang (CN); Jingwen WANG, Huzhou, Zhejiang (CN); Jinming WANG, Huzhou, Zhejiang (CN); Yu LI, Huzhou, Zhejiang (CN); Ronghua GAO, Huzhou, Zhejiang (CN); Guang HE, Huzhou, Zhejiang (CN)

(21) Appl. No.: 19/479,320

(22) PCT Filed: Dec. 27, 2023
(86) PCT No.: PCT/CN2023/142234

§ 371 Date: Oct. 27, 2025

(30) Foreign Application Priority Data
Apr. 28, 2023 (CN) 202310485998.8

(51) Int. Cl. C01G 53/04; C01B 32/198; H01M 4/04; H01M 4/485; H01M 4/62; H01M 4/66; H01M 4/76

(52) U.S. Cl. CPC C01G 53/04; C01B 32/198; H01M 4/0404; H01M 4/0471; H01M 4/485; H01M 4/625; H01M 4/661; H01M 4/76; C01P 2002/72; C01P 2002/82; C01P 2004/03; C01P 2004/04; C01P 2004/82; C01P 2006/40

(57) ABSTRACT

Provided is a method for preparing nano Nickel Oxide/Graphene Oxide composite electrode material. The preparation method includes the following steps: (1) respectively dissolving water-soluble nickel salt, Graphene Oxide, and gelatin into water to form a water-soluble nickel salt solution, a Graphene Oxide solution, and a gelatin solution; (2) adding the water-soluble nickel salt solution to the Graphene Oxide solution to form a mixed solution, adding the mixed solution to the gelatin solution, and performing heating and stirring to obtain a gel; and (3) drying the gel to obtain a nano Nickel Oxide/Graphene Oxide composite electrode material. A nano Nickel Oxide/Graphene Oxide composite electrode material prepared by the method, and an application of the electrode material in preparation of composite electrodes are also provided.

### CROSS-REFERENCE TO RELATED APPLICATIONS

The present application is a National Stage of International Patent Application No. PCT/CN2023/142234 filed on Dec. 27, 2023, which claims the benefit of priority to the Chinese Patent Application No. 202310485998.8 filed on Apr. 28, 2023, the content of both of which are incorporated by reference in their entirety.

### TECHNICAL FIELD

The present disclosure relates to the technical field of graphene composite batteries, and in particular, to method for preparing nano nickel oxide/graphene composite electrode material.

### BACKGROUND

Energy is the most important component of the continuous technological development in the world. In recent decades, the energy crisis has grown increasingly severe due to the high cost and limited supply of fossil fuels, coupled with mounting concerns over environmental pollution. The growing demand for energy and increasing concerns about global warming and air pollution have promoted intensive research into renewable energy and energy storage systems. Due to intermittent characteristics, the renewable energy faces challenges that need to be overcome. Therefore, high-efficiency energy storage methods represent a technical challenge for ensuring energy availability in the 21st century. Recently, green energy technologies have been applied to hybrid and electric vehicles, mobile phones, entertainment instruments, and space devices. Rapid charging and discharging, high volumetric energy density, low cost, legal resources, safety, environmental protection (recyclability), long service life, and high efficiency are key factors for future new energy storage apparatuses. Among alternative energy storage forms, electrical energy storage is one of the best technologies due to the fact that it may be transmitted over long distances and also considered as a clean energy source. A positive electrode plays a crucial role in energy storage systems. The porosity structure, specific surface area, and conductivity in an electrochemical reaction are special factors influencing energy storage capacity.

As an ideal matrix, graphene possesses numerous fascinating properties such as high conductivity, large specific surface area, and high mechanical flexibility, and has significant thermal stability and chemical stability. Extensive research is performed on the manufacturing of a graphene-transition metal oxide composite material for energy storage applications. The composite material may combine the advantages of two components, and generates special performance through mutual reinforcement or modification. Recently, the research group of Meryl D. Stoller reported the use of chemically-modified graphene as an electrode material for supercapacitors (Nano Lett 2008; 8(10):3498-502). The material has high conductivity and maintains excellent performance at a wide voltage scanning rate, but has relatively low specific capacitance.

As is well known, amorphous hydrated ruthenium oxide is the most promising electrode material for high-power, high-energy-density supercapacitors. However, its high cost, scarcity of resources, and the environmental pollution caused by electrolytes used have significantly limited its commercial development. Oxide electrode materials such as NiO have similar functions to RuO₂·xH₂O and are cost-effective. However, NiO has two critical drawbacks as a supercapacitor material: one is its relatively poor conductivity, and the other is the tendency of agglomeration of a NiO nano material. In recent years, compared with commercially available NiO, gradient porous NiO synthesized by Cheng et al. (J Power Sources 2008; 185(2):1563-68.) using a template method is used as an electrode material for the supercapacitors, and has better capacitance, power density, and energy density compared with commercially available NiO, but has poor stability at high voltages.

One of the current research hotspots is the research of nickel oxide and graphene composite materials. The composite materials can exert their respective advantages, overcome the drawbacks of individual materials, and broaden the scope of material applications. Disclosed in the patent CN101733985A is a graphene/nickel oxide layered structure composite thin film and a preparation method thereof. Graphene is mixed with nickel oxide by using an ultrasonic method; and then, the graphene/nickel oxide layered structure composite thin film is obtained through high-temperature heat treatment. A composite film prepared by the method has good conductivity and mechanical strength, but needs to be obtained through a high-temperature sintering treatment and has long reaction time. The patent CN102522218A reports a nano nickel oxide/graphene composite electrode material and a preparation method and application thereof. The high conductivity of reduced graphene is mainly used to reduce the internal resistance of a composite electrode, and the high specific surface area and its inherent ability to function as a double-layer capacitor improve the high-power discharging capability of a composite capacitor. The nickel oxide/graphene composite electrode material has a pore size of 2-65 nm and an average nano nickel oxide particle size of 750 nm. Although the method has improved the specific capacitance of the composite material to certain extent, the nano nickel oxide with the average particle size of 750 nm limits its electrochemical performance.

Electrodes prepared in the related art are relatively low in capacity and poor in reversibility, and the charging speed of batteries prepared needs to be further improved, thus limiting the use of the batteries in more fields.

### SUMMARY

An overview of the subject is described in detail below herein. The overview is not intended to limit the scope of protection of the claims.

In view of the disadvantages in the related art, the present disclosure provides method for preparing nano Nickel oxide/Graphene (NiO-GO) composite electrode material, thereby improving electrode capacity and reversibility. A battery prepared by the electrode material prepared in the present disclosure has the technical effect of a faster charging speed and a low battery loss, so as to solve at least one technical problem proposed in the above BACKGROUND, belong to the technical field of graphene composite batteries.

In order to implement the above objective, the present disclosure is implemented through the following technical solutions.

A first aspect of the present disclosure provides a method for modifying NiO NPs on Graphene Oxide (GO) NiO NPs is modified on the Graphene Oxide (GO) using a sol-gel method, that is, a method for preparing a nano composite electrode material includes the following steps:
(1) Water-soluble nickel salt, Graphene Oxide, and gelatin into water are respectively dissolved to form a water-soluble nickel salt solution, a Graphene Oxide solution, and a gelatin solution.
(2) The water-soluble nickel salt solution is added to the Graphene Oxide solution to form a mixed solution, the mixed solution is added to the gelatin solution, and heating and stirring are performed to obtain a gel.
(3) The gel is dried to obtain a nano nickel oxide/graphene composite electrode material.

A mass ratio of the water-soluble nickel salt, the Graphene Oxide, and the gelatin is 80-200:1:40-125.

A particle size in the related art is approximately 500 nm, and a particle size prepared by the method of the present disclosure is approximately 10 nm. A reagent must be used in the sol-gel method to control the particle size. The applicant uses gelatin. The synthetic nanoparticles have high quality and uniform sizes, and the gelatin may be removed at 300° C.

In an exemplary embodiment of the method for modifying NiO NPs on Graphene Oxide (GO) of the present disclosure, the water-soluble nickel salt is at least one of nickel nitrate, nickel sulfate, nickel acetate, nickel chloride, or nickel sulfite.

In an exemplary embodiment of the method for modifying NiO NPs on Graphene Oxide (GO) of the present disclosure, in step (1), when being dissolved in water, the gelatin is dissolved by heating in a water bath, and a temperature is held at 60-80° C.

Specifically, the Graphene Oxide is prepared according to a Hummers method. The Hummers method includes the following steps: magnetic stirring and mixing are performed on a 0.1-2 M sulfuric acid solution, a 0.1-2 M phosphoric acid solution, a graphite sheet, and potassium permanganate uniformly to obtain mixed liquid, where a mass ratio of the sulfuric acid solution, the phosphoric acid solution, the graphite sheet, and the potassium permanganate is 50-170:10-50:1:2.67-12; after the color of the mixed liquid changes from deep purple-green to dark brown, and a H₂O₂ solution is gradually added to undergo a racemization reaction for 10-15 min, that is, when the color of the mixed liquid changes to bright yellow, a reaction solution is obtained; and centrifugal washing is performed on supernatant of the reaction solution to obtain the Graphene Oxide.

For the composite GO with a low rate obtained in the present disclosure, and compared to using Reduced Graphene Oxide (RGO) for achieving a large capacity at a high rate, and considering that the RGO is more expensive than the GO, the present disclosure is more suitable for industrial production.

In an exemplary embodiment of the method for modifying NiO NPs on Graphene Oxide (GO) of the present disclosure, a volume concentration of the H₂O₂ solution is 30%, and an amount of the H₂O₂ solution added is 30 mL.

In an exemplary embodiment of the method for modifying NiO NPs on Graphene Oxide (GO) of the present disclosure, in step (2), the mixed solution is added to the gelatin solution for heating and stirring, the temperature is held at 60-80° C.

In an exemplary embodiment of the method for modifying NiO NPs on Graphene Oxide (GO) of the present disclosure, in step (3), a drying condition is that the temperature is heated to 300-350° C. at a rate of 20-30° C./min and held for 1-3 h at 300-350° C.

The present disclosure further provides a nano Nickel Oxide/Graphene Oxide composite electrode material prepared by the preparation method.

The present disclosure further provides an application of the nano Nickel Oxide/Graphene Oxide composite electrode material in preparation of composite electrodes.

A method for preparing the composite electrode includes: 60-80 wt. % of NiO/GO powder and 12-18 wt. % of acetylene black are mixed to prepare a NiO/GO electrode; a slurry is prepared by using 8-12 wt. % polyvinylenedifluoride (PVDF) and N-Methyl-2-Pyrrolidone (NMP) as solvents, and then coated on a surface of cleaned nickel foil (with a thickness of 0.125 mm and an area of 1 cm²); and the nickel foil is dried in air for 12-16 hours at 80-90° C. in a horizontal furnace tube, where the mass of the NiO/GO composite material on each electrode is approximately between 1 and 2 mg.

In an exemplary embodiment of the method for preparing a NiO/GO composite material electrode of the present disclosure, the amount of the N-Methyl-2-Pyrrolidone (NMP) used is 20-35 parts of the NMP for every 10 parts of an active material.

Beneficial effects are as follows.

To sum up, the method for preparing a NiO/GO composite electrode material provided in the present disclosure has the following beneficial effects:
1) By controlling the size and the composite GO with a low rate to achieve a high capacity, the capacity of the NiO-Graphene Oxide composite electrode is effectively improved, with an improvement exceeding 50%.
2) The NiO-Graphene Oxide composite electrode has better reversibility, with an average reversible potential increased by up to 20 mV.
3) The NiO/GO composite material electrode has a faster charging speed, and a charging time may be effectively shortened by more than 20%.

After reading and understanding the drawings and detailed description, other aspects may become apparent.

### BRIEF DESCRIPTION OF THE DRAWINGS

The drawings are used to provide a further understanding of the technical solutions here, and constitute a part of the specification, which are used to explain the technical solutions here with the embodiments of the present disclosure, and do not constitute a limitation of the technical solutions here.

FIG. 1 is a pre-fabricated electrode diagram, where a represents various material for preparing electrodes, and b represents an electrode material and an electrode diagram coated using Pipette gun.

FIG. 2 is an electrochemical measurement process diagram of a coating NiO/GO using a three-electrode system, where (a) represents a potentiostat (Versa STAT 3, AMETEK), and (b) represents a three-electrode system electrochemical battery.

FIG. 3 is an XRD diagram of NiO NPs prepared in Embodiment 1 and a NiO/GO (1%) composite material prepared in Embodiment 3 after calcination at 300° C.

FIG. 4 is a Raman spectrum of NiO prepared in Embodiment 1 and NiO/GO prepared in Embodiment 3.

FIG. 5 is an FESEM image of a shape of NiO/GO prepared in Embodiment 3.

FIG. 6 is an HRTEM image of a nanoparticle structure of NiO/GO prepared in Embodiment 3, where (a) is a TEM image of a NiO NPs-modified GO sheet, and (b) is a NiO diagram of a single nanoparticle adhering to a GO surface.

FIG. 7 is a cyclic voltammogram observed for NiO NPs calcined at 300° C. in 1 M KOH at scanning rates of 1, 5, 15, 20, and 30 mV/S in an electrochemical test of a NiO/GO composite material prepared in Embodiment 5.

FIG. 8 is a CV curve of NiO prepared in Comparative example 1 and a NiO/GO composite material prepared in Embodiment 5.

FIG. 9 is a charging and discharging test diagram of a NiO/GO electrode prepared in Embodiment 5 at different current densities.

FIG. 10 is a charging and discharging test diagram of NiO NPs prepared in Comparative example 1 and a NiO/GO electrode prepared in Embodiment 5.

### DETAILED DESCRIPTION OF THE EMBODIMENTS

### Embodiment 1

### Preparation of NiO Particles

4 g of Ni(NO₃)₂·6H₂O was dissolved in 20 mL of deionized water, and then stirred for 30 minutes. At the same time, 2 g of gelatin was dissolved in 40 mL of deionized water, and then stirred for 45 minutes at 40° C., so as to obtain a clear gelatin solution. Then, a nickel nitrate solution was added to the gelatin solution, and heated in a 60° C. water bath while stirring. Stirring was continuously performed for 15 hours to obtain a honey-like bright green gel. Then the green gel was put into a furnace. The furnace was heated to 300° C. from room temperature at a rate of 25° C./min. After a final temperature was held for 2 hours, the furnace was naturally cooled to room temperature, so as to obtain nano nickel oxide (NiO NPs).

### Embodiment 2

8 g of NiSO₄·6H₂O was dissolved in 40 mL of deionized water, and then stirred for 45 minutes. At the same time, 4 g of gelatin was dissolved in 80 mL of deionized water, and then stirred for 30 minutes at 60° C., so as to obtain a clear gelatin solution. Then, a nickel sulfate solution was added to the gelatin solution, and heated in an 80° C. water bath while stirring. Stirring was continuously performed for 10 hours to obtain a honey-like bright green gel. Then the green gel was put into a furnace. The furnace was heated to 300° C. from room temperature at a rate of 25° C./min. After a final temperature was held for 2 hours, the furnace was naturally cooled to room temperature, so as to obtain nano nickel oxide (NiO NPs).

### Embodiment 3

A process for preparing a nano NiO/GO composite material specifically included the following steps.

At S1, 320 mL of H₂SO₄ (0.1 M), 80 mL of H₃PO₄ (0.1 M), 3 g of a graphite sheet, and 18 g of KMnO4 were slowly added to a reactor, and a magnetic stirrer was used to perform a mixing process to oxidize graphite. The color of the mixture changed from deep purple-green to dark brown. Then, 30 mL of a H₂O₂ solution with a volume concentration of 30% was added to stop the oxidation process, and the color of the mixture changed to bright yellow. The formed Graphene Oxide was washed for three times with a 1 M HCl aqueous solution until the pH was 4-5, and was repeatedly washed with deionized water. Simple decantation was performed on supernatant through a centrifugation technique, so as to perform the washing process. During the washing process using the deionized water, the Graphene Oxide was subjected to peeling off, leading to the thickening of the graphene solution, thereby forming a GO gel.

At S2, 4 g of Ni(NO₃)₂·6H₂O and 0.04 g of the GO were respectively dissolved in 20 mL of deionized water, and then stirred for 30 minutes. Then, a nickel nitrate solution was slowly added to the GO solution. At the same time, 2 g of gelatin was dissolved in 40 mL of deionized water, and then stirred for 45 minutes at 60° C., so as to obtain a clear gelatin solution. Then, a nickel nitrate/GO solution was added to the gelatin solution, and heated in a 60° C. water bath while stirring. Stirring was continuously performed for 15 hours to obtain a honey-like black gel. The black gel was put into a furnace, and the furnace was heated to 300° C. from room temperature at a rate of 25° C./min. After a final temperature was held for 2 hours, the furnace was naturally cooled to room temperature, so as to obtain a Nickel Oxide/Graphene Oxide (NiO/GO) composite material.

### Embodiment 4

### Modification of NiO NPs on Graphene Oxide (GO)

At S1, 320 mL of H₂SO₄ (2 M), 80 mL of H₃PO₄ (2 M), 3 g of a graphite sheet, and 18 g of KMnO₄ were slowly added to a reactor, and a magnetic stirrer was used to perform a mixing process to oxidize graphite. The color of the mixture changed from deep purple-green to dark brown. Then, 30 mL of a H₂O₂ solution with a volume concentration of 30% was added to stop the oxidation process, and the color of the mixture changed to bright yellow, indicating that the oxidation level of the graphite was very high. The formed Graphene Oxide was washed for three times with a 1 M HCl aqueous solution until the pH was 4-5, and was repeatedly washed with deionized water. Simple decantation was performed on supernatant through a centrifugation technique, so as to perform the washing process. During the washing process using the deionized water, the Graphene Oxide was subjected to peeling off, leading to the thickening of the graphene solution, thereby forming a GO gel.

At S2, 8 g of NiSO₄·6H₂O and 0.08 g of the GO were respectively dissolved in 40 mL of deionized water, and then stirred for 45 minutes. Then, a nickel sulfate solution was slowly added to the GO solution. At the same time, 5 g of gelatin was dissolved in 40 mL of deionized water, and then stirred for 30 minutes at 80° C., so as to obtain a clear gelatin solution. Then, a nickel nitrate/GO solution was added to the gelatin solution, and heated in an 80° C. water bath while stirring. Stirring was continuously performed for 12 hours to obtain a honey-like black gel. The black gel was put into a furnace, and the furnace was heated to 350° C. from room temperature at a rate of 25° C./min. After a final temperature was held for 2 hours, the furnace was naturally cooled to room temperature, so as to obtain a Nickel Oxide/Graphene Oxide (NiO/GO) composite material.

### Embodiment 5

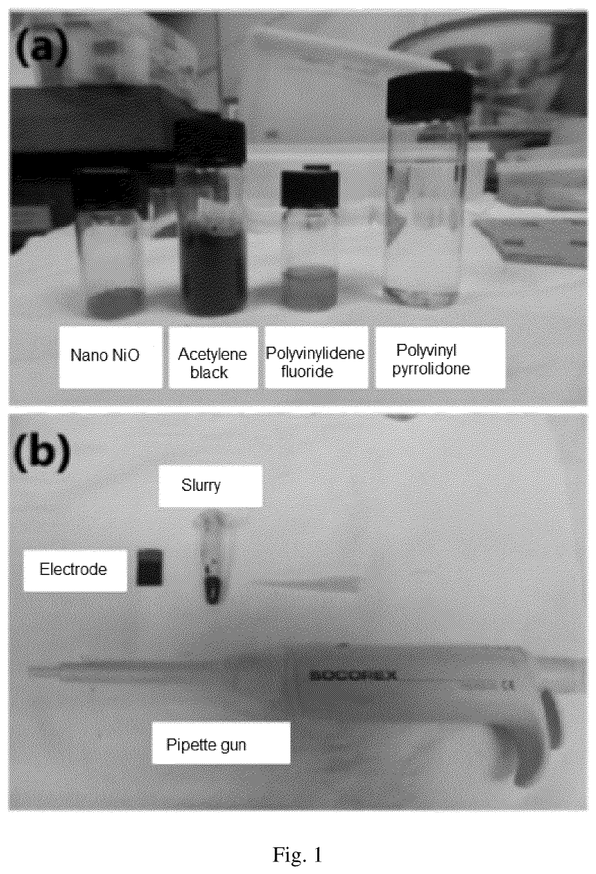

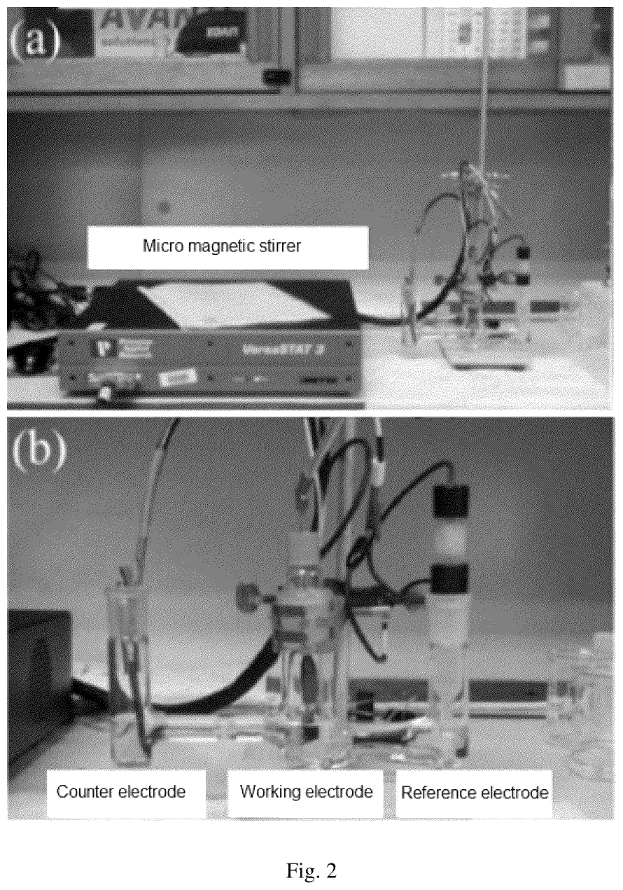

FIG. 1 was a pre-fabricated electrode diagram, where a represented various material for preparing electrodes, and b represented an electrode material and an electrode diagram coated using Pipette gun. FIG. 2 was an electrochemical measurement process diagram of a coating NiO/GO using a three-electrode system, where (a) represented a potentiostat (Versa STAT 3, AMETEK), and (b) represented a three-electrode system electrochemical battery. A specific preparation process was as follows.

### Preparation of NiO/GO Composite Material Electrode

80 wt. % of NiO/GO powder (prepared in Embodiment 3) and 18 wt. % of acetylene black were mixed to prepare a NiO/GO electrode; a slurry was prepared by using 12 wt. % of polyvinylenedifluoride (PVDF) and N-Methyl-2-Pyrrolidone (NMP) as solvents, and then coated on a surface of cleaned nickel foil (with a thickness of 0.125 mm and an area of 1 cm²); and the nickel foil was dried in air for 16 hours at 90° C. in a horizontal furnace tube, so as to obtain the NiO/GO composite material electrode, where the mass of the NiO/GO composite material on each electrode was approximately 2 mg.

The amount of the N-Methyl-2-Pyrrolidone (NMP) used was 35 mL of the NMP for every 10 g of an active material (NiO+acetylene black+PVDF).

### Embodiment 6

### Preparation of NiO/GO Composite Material Electrode

60 wt. % of NiO/GO powder (prepared in Embodiment 4) and 18 wt. % of acetylene black were mixed to prepare a NiO/GO electrode; a slurry was prepared by using 12 wt. % of polyvinylenedifluoride (PVDF) and N-Methyl-2-Pyrrolidone (NMP) as solvents, and then coated on a surface of cleaned nickel foil (with a thickness of 0.125 mm and an area of 1 cm²); and the nickel foil was dried in air for 16 hours at 90° C. in a horizontal furnace tube, so as to obtain the NiO/GO composite material electrode, where the mass of the NiO/GO composite material on each electrode was approximately 2 mg.

The amount of the N-Methyl-2-Pyrrolidone (NMP) used was 35 mL of the NMP for every 10 g of an active material (NiO+acetylene black+PVDF).

### Comparative Example 1

### Preparation of Nio Composite Material Electrode

80 wt. % of NiO powder (prepared in Embodiment 1) and 12 wt. % of acetylene black were mixed to prepare a NiO electrode; a slurry was prepared by using 8 wt. % of polyvinylenedifluoride (PVDF) and N-Methyl-2-Pyrrolidone (NMP) as solvents, and then coated on a surface of cleaned nickel foil (with a thickness of 0.125 mm and an area of 1 cm²); and the nickel foil was dried in air for 12 hours at 80° C. in a horizontal furnace tube, so as to obtain the NiO composite material electrode, where the mass of the NiO composite material on each electrode was approximately 1 mg.

The amount of the N-Methyl-2-Pyrrolidone (NMP) used was 20 mL of the NMP for every 10 g of an active material (NiO+acetylene black+PVDF).

### Test Example 1

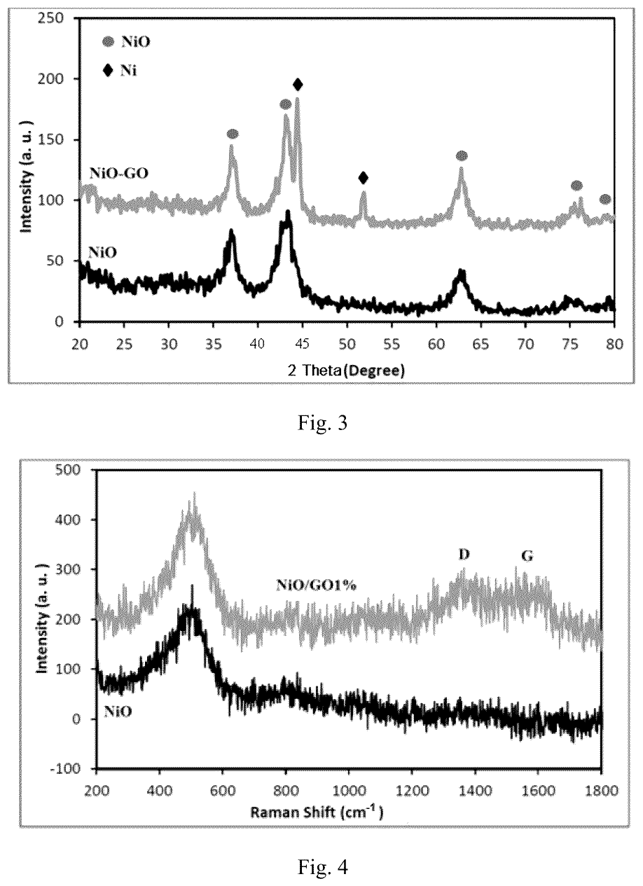

Nano nickel oxide prepared in Embodiment 1 and NiO/GO prepared in Embodiment 3 were characterized respectively. An XRD diagram of NiO NPs and NiO/GO (1%) composite materials after calcination was shown in FIG. 3.

Raman spectrum results for the NiO and NiO/GO were shown in FIG. 4. A NiO/GO sample had two peaks near 1380 cm⁻¹ and 1600 cm⁻¹, which respectively corresponded to a D band and a G band of graphene. Generally, a D/G intensity ratio was related to a sp²/sp³ carbon ratio, and was an amorphous state.

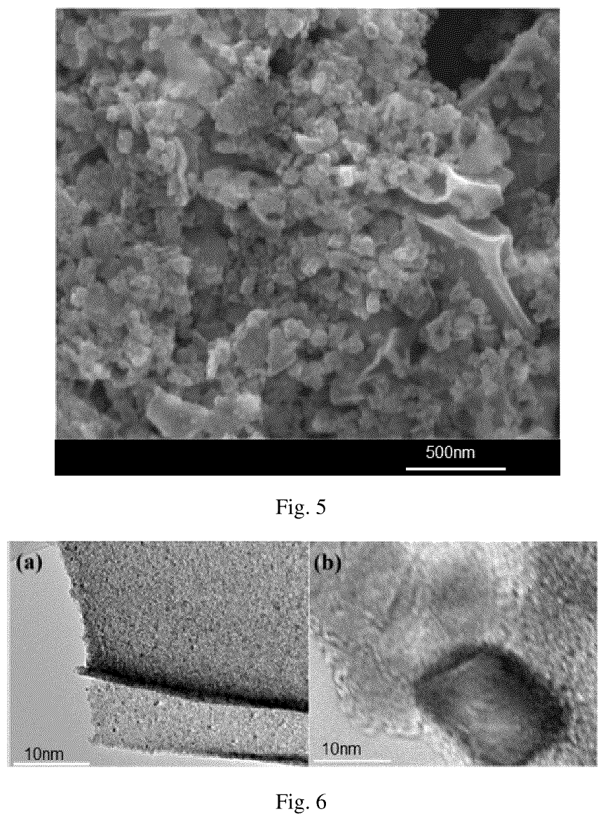

The shape of the NiO/GO composite material was studied by recording FESEM. Results were shown in FIG. 5. NiO NP was aggregated through vander-Wals interaction. Most graphene nanosheets curled and twisted together, so as to form a layered structure. An (a)TEM image in FIG. 6 showed that the NiO NP was modified on the GO sheet. Furthermore, the TEM image showed that an average particle size of nanoparticles was approximately 8.7 nm. (b) in FIG. 6 showed an HRTEM image of the single NiO NP. It might be seen that, the nanoparticles were single crystals with high crystal quality, and had no defects caused by stacking failures. Furthermore, the HRTEM image showed that a lattice distance was approximately 0.21 nm.

### Test Example 2

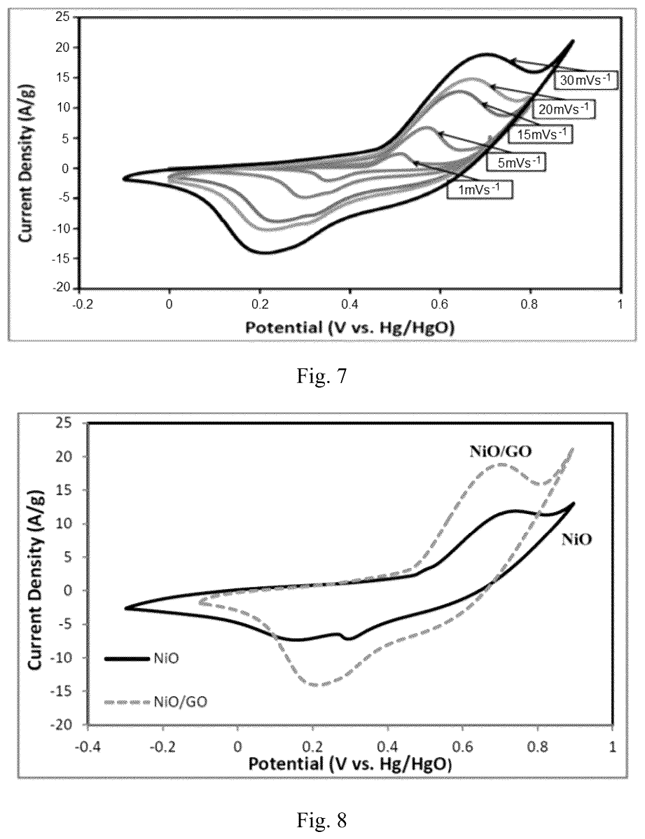

A capacity Cyclic Voltammetry (CV) technology was improved to study the electrochemical performance of NiO NPs generated by using a sol-gel method as an electrode material. FIG. 7 showed a cyclic voltammogram observed for NiO NPs calcined at 300° C. at scanning rates of 1, 5, 15, 20, and 30 mV/S.

A CV diagram of the NiO/GO electrode at different scanning rates showed that current densities and potentials at an oxidation peak and a reduction peak were increased. A shift in a redox peak was attributed to a rapid ion/electron diffusion rate, as well as enhanced polarization and irreversible reactions at a high scanning rate. This was because the reaction was limited by the ion diffusion rate.

The NiO/GO compound obtained by the cyclic voltammetry was compared with the NiO NP, as shown in FIG. 8. The potentials at the redox peak in a CV pattern respectively represented Ea and Ec. It was found that the NiO/GO electrode showed good reversibility in a faradic reaction. Therefore, during reaction, compared with the NiO NP, electrolyte ions might diffuse in a porous structure of the NiO/GO composite material more easily.

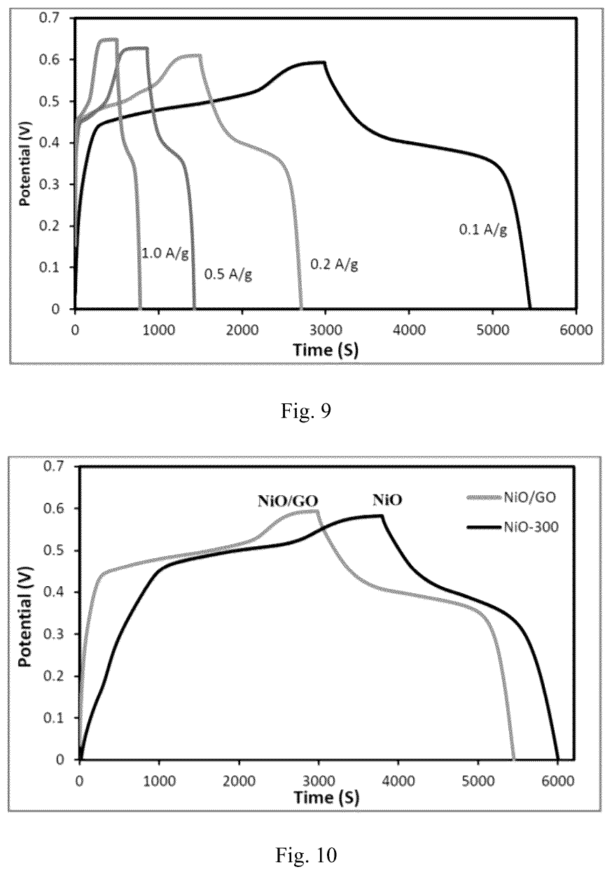

FIG. 9 showed charging/discharging measurement of the NiO/GO electrode at different current densities in 1 M KOH. From the figure, it might be seen that by increasing the current density, the charging/discharging time was shortened, and a potential window was increased. A non-linear charging/discharging curve verified a pseudo-capacitive behavior of the NiO/GO electrode, which was consistent with CV results.

In order to study the impact of the Graphene Oxide and NiO NPs, charging/discharging was performed on the NiO NPs and NiO/GO electrodes under the same conditions. Results were shown in FIG. 10, the charging time of the NiO/GO was shorter than that of the NiO NPs electrode, and the discharging time of the NiO/GO was longer than that of the NiO NPs electrode. The short charging time of the NiO/GO electrode was due to the presence of the graphene, the graphene improved the conductivity of the electrode material, and ions therein might diffuse more quickly on surface of inner and outer pores of the NiO/GO than the NiO-NPs electrode.

What is claimed is:

1. A method for preparing a nano Nickel Oxide/Graphene Oxide composite electrode material, wherein the preparation method comprises the following steps:
(1) respectively dissolving water-soluble nickel salt, Graphene Oxide, and gelatin into water to form a water-soluble nickel salt solution, a Graphene Oxide solution, and a gelatin solution;
(2) adding the water-soluble nickel salt solution to the Graphene Oxide solution to form a mixed solution, adding the mixed solution to the gelatin solution, and performing heating and stirring to obtain a gel; and
(3) drying the gel to obtain a nano Nickel Oxide/Graphene Oxide composite electrode material, wherein
a mass ratio of the water-soluble nickel salt, the Graphene Oxide, and the gelatin is 80-200:1:40-125.

2. The method for preparing a nano Nickel Oxide/Graphene Oxide composite electrode material according to claim 1, wherein the water-soluble nickel salt is at least one of nickel nitrate, nickel sulfate, nickel acetate, nickel chloride, or nickel sulfite.

3. The method for preparing a nano Nickel Oxide/Graphene Oxide composite electrode material according to claim 1, wherein in step (1), when being dissolved in water, the gelatin is dissolved by heating in a water bath, and a temperature is held at 60-80° C.

4. The method for preparing a nano Nickel Oxide/Graphene Oxide composite electrode material according to claim 1, wherein the Graphene Oxide is prepared according to a Hummers method; and the Hummers method comprises the following steps: performing magnetic stirring and mixing on a 0.1-2 M sulfuric acid solution, a 0.1-2 M phosphoric acid solution, a graphite sheet, and potassium permanganate to obtain mixed liquid, wherein a mass ratio of the sulfuric acid solution, the phosphoric acid solution, the graphite sheet, and the potassium permanganate is 50-170:10-50:1:2.67-12; gradually adding a H₂O₂ solution to undergo a racemization reaction for 10-15 min, so as to obtain a reaction solution; and performing centrifugal washing on supernatant of the reaction solution to obtain the Graphene Oxide.

5. The method for preparing a nano Nickel Oxide/Graphene Oxide composite electrode material according to claim 4, wherein a volume concentration of the H₂O₂ solution is 30%, and an amount of the H₂O₂ solution added is 30 mL.

6. The method for preparing a nano Nickel Oxide/Graphene Oxide composite electrode material according to claim 1, wherein in step (2), the mixed solution is added to the gelatin solution for heating and stirring, the temperature is held at 60-80° C.

7. The method for preparing a nano Nickel Oxide/Graphene Oxide composite electrode material according to claim 1, wherein in step (3), a drying condition is that the temperature is heated to 300-350° C. at a rate of 20-30° C./min and held for 1-3 h at 300-350° C..

8. A nano Nickel Oxide/Graphene Oxide composite electrode material prepared by the preparation method according to claim 1.

9. An application of the nano Nickel Oxide/Graphene Oxide composite electrode material according to claim 8 in preparation of composite electrodes.

10. The application according to claim 9, wherein a method for preparing the composite electrode comprises: mixing 60-80 wt. % of a nano nickel oxide/graphene composite electrode material and 12-18 wt. % of acetylene black to obtain a mixture, mixing the mixture with solvents to prepare into a slurry, coating the slurry on a surface of a nickel box, and performing drying in air for 12-16 hours at 80-90° C. in a horizontal furnace tube, so as to prepare into the composite electrode, wherein the solvents are Polyvinylenedifluoride and N-Methyl-2-Pyrrolidone.

11. The application according to claim 9, wherein the mass of the NiO/GO composite material on each composite electrode is between 1 and 2 mg.

12. The application according to claim 9, wherein the added amount of the Polyvinylenedifluoride is 8-12 wt. %.

13. The application according to claim 9, wherein the amount of the N-Methyl-2-Pyrrolidone used is 20-35 parts of the N-Methyl-2-Pyrrolidone for every 10 parts of an active material, the active material comprises NiO, acetylene black and Polyvinylenedifluoride.
